(19) United States
(12) Patent Application Publication
(10) Pub. No.: US 2025/0391982 A1
(43) Pub. Date: Dec. 25, 2025

(54) ELASTIC SHEET FOR ALL-SOLID-STATE RECHARGEABLE BATTERIES AND ALL-SOLID-STATE RECHARGEABLE BATTERIES

(71) Applicant: SAMSUNG SDI CO., LTD., Yongin-si, Gyeonggi-do (KR)

(72) Inventors: lk Hwan CHO, Yongin-si, Gyeonggi-do (KR); Byeongdo KWAK, Yongin-si, Gyeonggi-do (KR); Changhee WOO, Yongin-si, Gyeonggi-do (KR); Jinhwan PARK, Yongin-si, Gyeonggi-do (KR); Isaac SHIN, Yongin-si, Gyeonggi-do (KR); Riyul KIM, Yongin-si, Gyeonggi-do (KR); Eungyeong LEE, Yongin-si, Gyeonggi-do (KR)

(73) Assignee: SAMSUNG SDI CO., LTD., Yongin-si, Gyeonggi-do (KR)

(21) Appl. No.: 18/880,477

(22) PCT Filed: Jan. 4, 2024
(86) PCT No.: PCT/KR2024/000231

§ 371 Date: Dec. 31, 2024

(30) Foreign Application Priority Data
Mar. 10, 2023 (KR) 10-2023-0032013

(51) Int. Cl. H01M 50/242; H01M 50/218

(52) U.S. Cl. CPC H01M 50/242; H01M 50/218

(57) ABSTRACT

The present invention relates to an elastic sheet for an all-solid-state rechargeable battery having a thickness of 100 μm to 10 mm, a permanent strain of less than 50% at 45° C., a permanent strain of less than 50% at 45° C., an impact absorption rate of greater than or equal to 50% upon ball drop (7 g, 20 cm), and a compressive strength of 2.0 MPa to 6.0 MPa at CFD of 70%, and an all-solid-state rechargeable battery including the same.

### TECHNICAL FIELD

Elastic sheets for all-solid-state rechargeable batteries and all-solid-state rechargeable batteries including the same are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire in the event of collision, penetration, and the like. Accordingly, semi-solid batteries or all-solid-state batteries which use no electrolyte solution have been proposed. All-solid-state batteries refer to batteries made of all solid materials and particularly, using a solid electrolyte. Such all-solid-state batteries are safe due to no explosion risk according to leakage of the electrolyte solution and the like and thus may be easily manufactured into a thin battery.

### DISCLOSURE

The present invention provides an elastic sheet for an all-solid-state battery, which can relieve stress transmitted during the pressurizing process in the manufacture of an all-solid-state rechargeable battery and stress generated according to changes in the thickness of the battery during repeated charge and discharge, has excellent restoring force, and at the same time implements a moderately high compressive strength, thereby effectively suppressing cracks in a solid electrolyte or laminate film during the manufacturing process and charge and discharge process, and improving charge and discharge efficiency and cycle-life characteristics of an all-solid-state rechargeable battery.

In an embodiment, an elastic sheet for an all-solid-state rechargeable battery has a thickness of 100 μm to 10 mm, an impact absorption rate of greater than or equal to 50% upon ball drop (7 g, 20 cm), and a compressive strength of 2.0 MPa to 6.0 MPa at CFD of 70%.

In another embodiment, an all-solid-state rechargeable battery includes two or more unit cells including a positive electrode, a negative electrode, and a solid electrolyte layer between the positive electrode and the negative electrode, and the aforementioned elastic sheet located between the unit cells and/or at the outermost surface of the unit cells.

The elastic sheet for an all-solid-state rechargeable battery according to an embodiment of the present invention can relieve stress caused by changes in the thickness of a battery during repeated charge and discharge, has excellent restoring force, and at the same time implements a moderately high compressive strength, thereby effectively suppressing cracks from occurring in a solid electrolyte or laminate film during the manufacturing process and charge and discharge process, and improving the coulombic efficiency and cycle-life characteristics of an all-solid-state rechargeable battery.

### DESCRIPTION OF THE DRAWINGS

FIGS. 1 and 2 are cross-sectional views schematically showing all-solid-state rechargeable batteries according to embodiments.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### All-Solid-State Rechargeable Battery

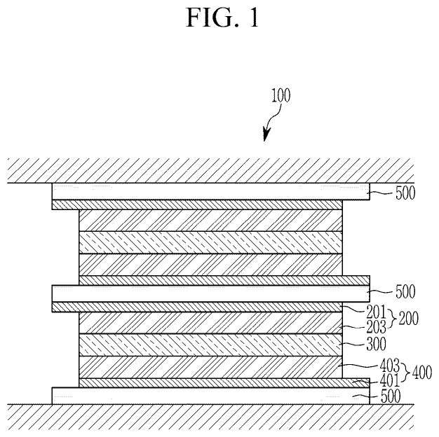

FIG. 1 is a cross-sectional view of an all-solid-state rechargeable battery according to an embodiment. Referring to FIG. 1, the all-solid-state rechargeable battery 100′ has a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100 further includes an elastic sheet 500 on the outer side of at least one of the positive electrode 200 and the negative electrode 400. FIG. 1 illustrates an assembly in which two unit cells including a negative electrode 400, a solid electrolyte layer 300, and a positive electrode 200 are stacked, but three or more, for example, 2 to 100, 3 to 50, 4 to 20, etc. may be stacked.

In all-solid-state rechargeable batteries 100, a sulfide-based solid electrolyte with high ionic conductivity is generally used. However, the sulfide-based solid electrolyte has a property of deteriorating in air, so that it is necessary to block it from the atmosphere. Therefore, an electrode assembly including the sulfide-based solid electrolyte is inserted into a case using a laminate film or a rigid material and then, sealed and pressed, manufacturing the battery. However, stress during the pressing may be transmitted to the solid electrolyte and thus break it, or as a thickness of an electrode changes according to charges and discharges, the stress is accumulated and causes a crack in the solid electrolyte, resulting in a short circuit. In addition, when not uniformly pressed from the outside during the battery discharge, lithium ions may move at a lower speed or toward a locally pressed region, deteriorating discharge efficiency. Furthermore, the non-uniform pressing may break the solid electrolyte.

Accordingly, a technique of applying an elastic sheet 500 to the outside of the electrode assembly has been developed. Here, the elastic sheet 500 may be a buffer layer or an elastic layer, and serves to ensure that pressure is uniformly transmitted to the electrode assembly to ensure good contact between solid components, and also to relieve stress transmitted to the solid electrolyte, etc., and can serve to suppress cracks from occurring in the solid electrolyte due to stress accumulation according to changes in the thickness of the electrode during charging and discharging.

As shown in FIG. 1, the elastic sheet 500 may be located between unit cells and may also be located on the outermost layer surface of the unit cell. Considering that the thickness of the negative electrode changes significantly during charge and discharge, especially due to lithium deposition or dendrite formation, the elastic sheet 500 can buffer problems due to thickness changes by being located on the outer side of the negative electrode, that is, on the opposite side of the surface where the solid electrolyte layer is in contact with the negative electrode. In addition, since the elastic sheet 500 is on the outside of the positive electrode and/or negative electrode, deterioration caused by reaction with lithium may be prevented, and thus, an effect of increasing coulombic efficiency of the battery may be obtained.

However, existing silicone-based elastic sheets have the disadvantages of being difficult to implement in a thin thickness and being expensive, and rubber-based elastic sheets have excellent restoring force, but lack stress relaxation characteristics, and thus there are limitations in implementing a long cycle-life.

### Elastic Sheet

In an embodiment, an elastic sheet for an all-solid-state rechargeable battery has a thickness of 100 μm to 10 mm, a permanent strain of less than 50% at 45° C., an impact absorption rate of greater than or equal to 50% upon ball drop (7 g, 20 cm), a compressive strength of 2.0 MPa to 6.0 MPa at CFD of 70%. An elastic sheet satisfying these properties can effectively alleviate stress due to thickness change during charge and discharge of an all-solid-state rechargeable battery and improve coulombic efficiency and cycle-life characteristics.

The thickness of the above elastic sheet is in a range of 100 μm to 1 mm, for example 100 μm to 900 μm, 100 μm to 800 μm, or 200 μm to 700 μm. For example, the elastic sheet may have a different thickness depending on the location, for example, the thickness of the elastic sheet located between the unit cells may be 100 μm to 300 μm, and the thickness of the elastic sheet located at the outermost edge of the unit cell may be 700 μm to 1 mm.

The above properties, such as permanent strain, impact absorption rate, and compressive strength may be measured while the thickness of the elastic sheet is adjusted within the range of 100 μm to 10 mm. For example, the measurements may be taken after manufacturing a single elastic sheet with a thickness of 100 μm to 1 mm and then laminating several layers to have a thickness of 10 mm. Specifically, the measurements may be taken after laminating 20 elastic sheets each having a thickness of 500 μm to make a thickness of 10 mm.

The elastic sheet is characterized by having a permanent strain of less than 50%. Here, the permanent strain may mean a value measured after compression at 0.5 MPa at 45° C. for 30 days, and may be an absolute value of the thickness of the specimen recovered after compression minus the original thickness of the specimen divided by the original thickness of the specimen, and may be a value calculated through Calculation Equation 1.

$$Permanent strain ( \% ) = \{ \vert ( thickness of specimen recovered after compression ) - ( initial thickness of specimen ) \vert / ( initial thickness of specimen ) \} \times 100 \qquad [ Calculation Equation 1 ]$$

The permanent strain of the elastic sheet may be less than 50%, or less than 49%, for example, 30% to 49%, 40% to 49%, or 45% to 49%. When the elastic sheet satisfies the permanent strain in the above ranges, it can effectively alleviate stress changes due to charge and discharge while providing appropriate compressive strength to the all-solid-state rechargeable battery, thereby improving the coulombic efficiency and cycle-life characteristics of the all-solid-state rechargeable battery.

The elastic sheet is characterized by having an impact absorption rate of greater than or equal to 50%. Here, the impact absorption rate may be measured according to the ball drop method, which measures the impact force (N) generated by dropping a 7 g weight from a vertical height of 20 cm on an elastic sheet specimen at 25° C., and can be specifically calculated through Calculation Equation 2.

$$Impact absorption rate ( \% ) = \{ [ ( impact force measured without specimen ) - ( impact force on specimen ) ] / ( impact force measured without specimen ) \} \times 100 \qquad [ Calculation Equation 2 ]$$

The impact absorption rate of the above elastic sheet may be greater than or equal to 50%, or greater than or equal to 51%, or greater than or equal to 52%, for example, 50% to 65%, 51% to 60%, or 52% to 58%. These elastic sheets can effectively alleviate stress changes due to charge and discharge while providing appropriate compressive strength to all-solid-state rechargeable batteries, and can improve the coulombic efficiency and cycle-life characteristics of all-solid-state rechargeable batteries.

The elastic sheet is characterized by having a compressive strength of 2.0 MPa to 6.0 MPa at CFD of 70%. Here, the compressive strength is the value at CFD (Compression Force Deflection) 70%, which means the compressive strength at the point where the elastic layer is physically compressed by 70% at 25° C., that is, the point where the thickness after pressurization becomes 30% of the initial thickness, and can be a value calculated using Calculation Equation 3.

$$Compressive strength ( M P a ) = \{ [ Load at 70 \% compression ( kgf ) ] / [ area of specimen ( {cm}^{2} ) ] \} \times 0.1 \qquad [ Calculation Equation 3 ]$$

The compressive strength at CFD of 70% of the elastic sheet may be, for example, 2.0 MPa to 5.0 MPa, or 2.5 MPa to 6.0 MPa, or 3.0 MPa to 6.0 MPa.

The above elastic sheet may have a compressive strength at CFD of 40% of 0.5 MPa to 1.5 MPa, for example 0.6 MPa to 1.4 MPa, or 0.7 MPa to 1.3 MPa. The compressive strength at CFD of 40% refers to the compressive strength at the point where the thickness after pressurization becomes 60% of the initial thickness, and can be calculated using Calculation Equation 4.

$$Compressive strength ( M P a ) = \{ [ Load at 40 \% compression ( kgf ) ] / [ Area of specimen ( {cm}^{2} ) ] \} \times 0.1 \qquad [ Calculation Equation 4 ]$$

The compressive strength at CFD of 70% of the elastic sheet can be at least three times %, for example between three and ten times, or between four and nine times the compressive strength at CFD of 40.

The density of the above elastic sheet may be, for example, 0.3 g/cm³ to 0.9 g/cm³, or, for example, 0.3 g/cm³ to 0.8 g/cm³.

The elastic sheet includes a polymer resin. Here, the polymer resin is not particularly limited in type as long as the elastic sheet can satisfy the aforementioned properties, but may include, for example, polyacrylate, polyurethane, silicone, fluorinated polymer, polyether polyol, polyester polyol, polycarbonate polyol, a copolymer thereof, or a combination thereof.

The polyacrylate means a homopolymer or copolymer having an acrylic group, and the polyurethane means a homopolymer or copolymer having a urethane group. The silicone may also be a silicone resin and means a homopolymer or copolymer including silicon, and the fluorine-based polymer means a homopolymer or copolymer including fluorine. These polymers can exhibit appropriate elasticity, modulus and compressive strain, making them suitable for use as elastic sheets.

The polymer resin may be polyether polyol for polyurethane. It is desirable that the polyether polyol has a functional group number of 2 to 4 and a number average molecular weight of 2,000 or more and 4,000 or less.

In addition to the polyether polyol, polyester polyol may be used. Examples of the polyester polyol may include those obtained by condensation of low molecular weight polyols such as ethylene glycol, diethylene glycol, propylene glycol, butanediol, hexanediol, glycerin, trimethylolpropane, trimethylolethane, pentaerythritol, diglycerin, sorbitol, and sucrose with succinic acid, adipic acid, maleic acid, fumaric acid, phthalic acid, isophthalic acid, succinic anhydride, maleic anhydride, and phthalic anhydride. In addition, the polyester polyol may be polyol that is a ring-opening condensate of caprolactone and methyl valerolactone, which are classified as lactone ester. Examples of the polycarbonate polyol may include those obtained by dealcoholization reaction between polyhydric alcohols such as ethylene glycol, diethylene glycol, propylene glycol, butanediol, pentanediol, and hexanediol and dialkyl carbonate, dialkylene carbonate, and diphenyl carbonate. It is more desirable that the functional group number is 2 to 3 and the number average molecular weight is 500 or more and 1000 or less (or the hydroxyl group number is 112 mgKOH/g or more and 224 mgKOH/g or less).

The polyacrylate may be derived from, for example, a C1 to C20 alkyl acrylate, a hydroxy C1 to C20 alkyl acrylate, or a combination thereof.

Here, C1 to C20 represent the number of carbon atoms in the alkyl group, and may be, for example, C1 to C18, C1 to C15, C1 to C12, C1 to C10, C1 to C8, C1 to C5. Here, the acrylate has a concept that includes acrylate and methacrylate.

The C1 to C20 alkyl acrylate can be, for example, methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate and 2-propyloctyl (meth)acrylate, or a combination thereof.

The hydroxy C1 to C20 alkyl acrylate may be, for example, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

For example, the acrylate resin may be derived from a C1 to C20 alkyl acrylate and a hydroxy C1 to C20 alkyl acrylate, and at this time, a mixing ratio of the C1 to C20 alkyl acrylate and the hydroxy C1 to C20 alkyl acrylate may be a weight ratio of 20:80 to 90:10, for example, a weight ratio of 30:70 to 90:10, 40:60 to 90:10, 50:50 to 90:10, 60:40 to 80:20. In this case, the acrylate resin can exhibit appropriate adhesiveness and is advantageous in implementing excellent compressive strength, stress relaxation rate, and recovery rate.

The acrylate resin may further include other repeating units derived from acrylic acid, an alkoxy group-containing acrylate, etc. Additionally, the weight average molecular weight of the acrylate resin may be from 400,000 to 2,000,000, but is not limited thereto.

The elastic sheet may further include hollow particles in addition to the polymer resin.

The hollow particles are particles with an empty interior and can be expressed as hollow spheres or hollow beads, and may be hollow nanoparticles or hollow microparticles. When the elastic sheet includes hollow particles, the compressive strength may be increased while maintaining an appropriate density, and the sheet may exhibit a foam shape.

The hollow particles may be included in an amount of 1 part by weight to 8 parts by weight, for example 1 part by weight to 7 parts by weight, 2 parts by weight to 6 parts by weight, based on 100 parts by weight of the polymer resin. When hollow particles are included in this content range, it is advantageous for making an elastic sheet in the form of a foam, and can improve the compressive strength, stress relaxation ability, and restoring force of the elastic sheet.

The hollow particles may be inorganic hollow particles, organic hollow particles, or a combination thereof. That is, the hollow particles may be composed of inorganic substances or organic substances such as polymers.

The inorganic hollow particles may include, for example, glass, metal oxide, metal carbide, metal fluoride, or a combination thereof. Specifically, the inorganic hollow particles may be formed of glass, silicon oxide, nickel oxide, barium oxide, platinum oxide, zinc oxide, aluminum oxide, zirconium oxide, iron oxide, titanium oxide, calcium carbonate, magnesium fluoride, or a combination thereof, and as an example, the inorganic hollow particles may be glass bubbles.

The organic hollow particles may include, for example, an acrylic resin, a vinyl chloride resin, a urea resin, a phenol resin, a rubber, or a combination thereof. Additionally, the organic hollow particles may be expandable or non-expandable, and the expandable organic hollow particles may be, for example, expandable at 120° C. to 150° C.

The size (D50) of the above hollow particles may be, for example, a micro size, and specifically may be 2 μm to 100 μm, 5 μm to 90 μm, 10 μm to 80 μm, or 20 μm to 70 μm. The hollow particles having such a size are advantageous for making elastic sheets in the form of foam, and may lower the density while improving the compressive strength of the elastic sheet and improving stress relaxation ability and restoring force. Here, the size of the hollow particles may be expressed as the average particle diameter or median particle diameter, and may mean a diameter of particles (D50) having a cumulative volume of 50 volume % in the particle size distribution as measured by a particle size analyzer.

The elastic sheet may further include elastic particles in addition to the polymer resin. The elastic particles may be particles made of a polymer having elasticity, such as rubber. The elastic particles may increase the restoring force while maintaining the stress relaxation ability of the polymer resin.

The elastic particles may be included in an amount of 0.1 parts by weight to 5 parts by weight, for example 0.5 parts by weight to 4 parts by weight, 1 part by weight to 3 parts by weight, based on 100 parts by weight of the polymer resin. When the elastic particles are included in this content range, the compressive strength, stress relaxation strength, and restoring force may be maximized without lowering the density and adhesiveness of the polymer resin.

The elastic particles may include polymers derived from, for example, natural rubber, alkyl acrylates, olefins, butadiene, isoprene, styrene, acrylonitrile, copolymers thereof, or a combination thereof. The elastic particles may have a glass transition temperature of, for example, −70° C. to 0° C.

The alkyl acrylate may be a C1 to C20 alkyl acrylate, and can be, for example, methyl (meth)acrylate, ethyl (meth)acrylate, propyl (meth)acrylate, butyl (meth)acrylate, 2-ethylhexyl (meth)acrylate, 2-ethylpentyl (meth)acrylate, 2-ethylheptyl (meth)acrylate, 2-ethylnonyl (meth)acrylate, 2-propylhexyl (meth)acrylate, and 2-propyloctyl (meth)acrylate, or a combination thereof.

The elastic particles may include, for example, polyalkyl acrylate, an ethylene-propylene-diene rubber, a butadiene rubber, an isoprene rubber, styrene-butadiene rubber, a styrene-isoprene rubber, an acrylonitrile-butadiene rubber, or a combination thereof.

The elastic particles may have, for example, a core-shell structure, in which case it is advantageous to exhibit appropriate size and elasticity. The core and shell may each include, for example, a polyalkyl acrylate, for example, the core may comprise polybutyl (meth)acrylate and the shell may include polymethyl (meth)acrylate. In this case, the dispersion within the elastic sheet composition is excellent, and the compressive strength, stress relaxation ability, and resilience of the elastic sheet can be improved.

The elastic particles may be, for example, nano-sized. Specifically, the size (D50) of the elastic particles may be 10 nm to 900 nm, for example 10 nm to 700 nm, 50 nm to 500 nm, or 100 nm to 400 nm. The elastic particles satisfying these sizes have excellent dispersibility within the elastic sheet composition and can increase the restoring force while maintaining the stress relaxation ability of the elastic sheet. Here, the size of the elastic particles may be expressed as an average particle diameter or median particle diameter, and may mean a diameter of the particles (D50) whose cumulative volume is 50 volume % in the particle size distribution as measured by a particle size analyzer.

The elastic sheet may further include inorganic particles. In this case, the modulus and compressive strength of the elastic sheet can be improved while simultaneously improving the recovery rate.

The inorganic particles may include, for example, alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

The inorganic particles may be included, for example, in an amount of 0.001 to 50 parts by weight, for example, 0.01 to 45 parts by weight, or 0.1 to 40 parts by weight, based on 100 parts by weight of the polymer resin. In this case, the compressive strength, stress relaxation rate, and recovery rate of the elastic sheet may be improved without deteriorating the properties of the polymer resin.

The average particle size of the aforementioned inorganic particles may be 0.1 μm to 2 μm, for example 0.1 μm to 1.5 μm, or 0.2 μm to 1.0 μm. The average particle size may be measured using a laser scattering particle size distribution meter, and may refer to the median particle size (D50) when 50% of the small particles are accumulated in volume conversion.

The elastic sheet may further include suitable additives in addition to the aforementioned components, for example, an initiator, a crosslinking agent, a coupling agent, a stabilizing agent, etc. In addition, in order to manufacture an elastic sheet in the form of a foam, the elastic sheet may include an inert gas such as nitrogen or argon in addition to or together with the foaming agent.

Each additive may be included in an appropriate amount according to the intended purpose, and may be included, for example, in an amount of 0.001 parts by weight to 20 parts by weight, for example 0.01 parts by weight to 10 parts by weight, 0.1 parts by weight to 5 parts by weight, or 1 part by weight to 3 parts by weight, based on 100 parts by weight of the polymer resin.

### Solid Electrolyte Layer

In an all-solid-state rechargeable battery according to an embodiment, the solid electrolyte layer 300 may include an inorganic solid electrolyte such as a sulfide-based solid electrolyte or an oxide-based solid electrolyte.

For example, the solid electrolyte layer 300 may include a sulfide-based solid electrolyte having excellent ionic conductivity. The sulfide-based solid electrolyte particles may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O-Lil, Li₂S—SiS₂, Li₂S—SiS₂-Lil, Li₂S—SiS₂—LiBr, Li₂S—SiS₂—LiCl, Li₂S—SiS₂—B₂S₃-Lil, Li₂S—SiS₂—P₂S₅-Lil, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.3}, etc.

The sulfide-based solid electrolyte including such an argyrodite-type sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle-life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The solid electrolyte layer 300 may include an oxide-based inorganic solid electrolyte. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃ (PZT), Pb₁₋ₓLaₓZr_{1-y}Ti_{y}O₃ (PLZT) (0≤x≤1, 0≤y≤1), PB(Mg₃Nb_{2/3})O₃—PbTiO₃ (PMN—PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Ta, Te, Nb, Zn, or Zr; and x is an integer of 1 to 10), or a mixture thereof.

The solid electrolyte is in the form of particles and may have an average particle diameter (D50) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte may be small particles having a size of 0.1 μm to 1.9 μm, large particles having a size of 2.0 μm to 5.0 μm, or a mixture thereof. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

Meanwhile, the average particle diameter (D50) of the solid electrolyte included in the solid electrolyte layer 300 may be larger than the average particle diameter (D50) of the solid electrolyte included in the positive electrode 200. In this case, the energy density of the all-solid-state rechargeable battery may be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery.

The solid electrolyte layer 300 may further include a binder in addition to the solid electrolyte. The binder may include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, polyvinylidene fluoride-hexafluoropropylene copolymer, polyvinyl chloride, carboxylated polyvinyl chloride, polyvinyl fluoride, polyethylene, polypropylene, an ethylene propylene copolymer, an ethylene propylene diene copolymer, polyamideimide, polyimide, poly(meth)acrylate, polyacrylonitrile, polystyrene, polyurethane, or a combination thereof.

The solid electrolyte layer 300 may be formed by adding a solid electrolyte to a binder solution, coating it on a substrate film, and drying it. The solvent of the binder solution may be isobutyryl isobutyrate, xylene, toluene, benzene, hexane or a combination thereof. Because the above solid electrolyte layer formation process is widely known in the art, a detailed description will be omitted.

The solid electrolyte layer 300 may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, Lil, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si—Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

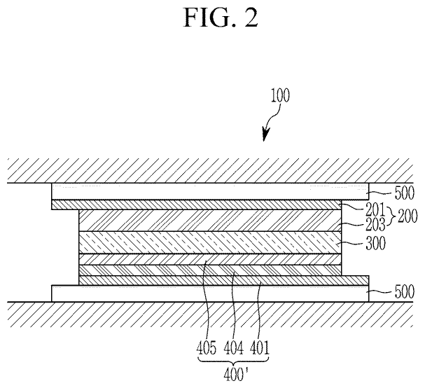

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Herein, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

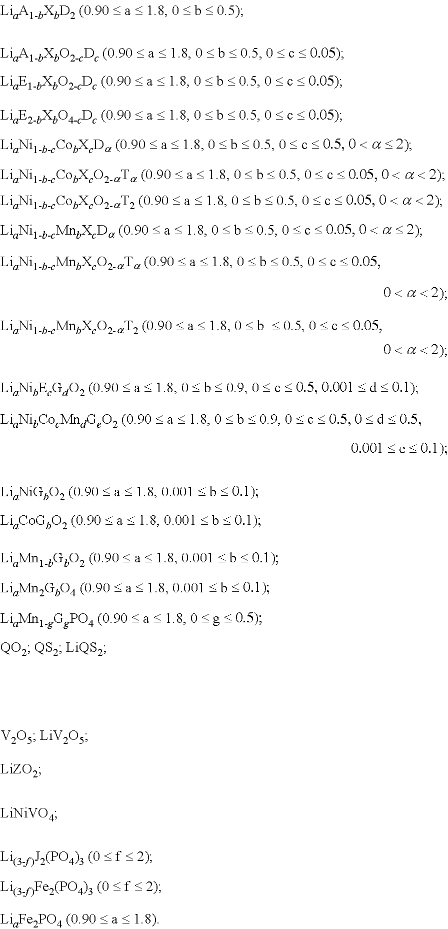

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

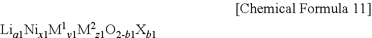

In Chemical Formula 11, 0.95≤a1≤1.8, 0.3≤x1≤1, 0≤y1≤0.7, 0≤z1≤0.7, 0.95≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

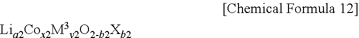

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

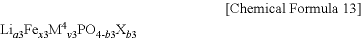

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

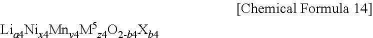

In Chemical Formula 14, 0.9≤a2≤1.8, 0.8≤x4≤1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Herein, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sₙ, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, detailed descriptions therefor is omitted.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

An all-solid-state rechargeable battery may be a unit cell with a structure of positive electrode/solid electrolyte layer/negative electrode, a bicell with a structure of negative electrode/solid electrolyte layer/positive electrode/solid electrolyte layer/negative electrode, or a stacked battery in which these structures are repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Manufacturing of Elastic Sheet

An acrylate polymer resin was prepared by mixing 4-hydroxybutyl acrylate (4-HBA, Osaka Organic Chemical Industry Ltd.), 2-ethylhexyl acrylate (2-EHA, LG Chem), and isobornylacrylate (IBOA, Osaka Organic Chemical Industry Ltd.) in a weight ratio of 25:65:10 and adding 0.01 parts by weight of a photoinitiator (Irgacure 651) thereto and then, exchanging oxygen dissolved in a reactor with nitrogen gas and irradiating ultraviolet rays thereinto with a lamp having UV intensity of 10 mw/cm² for several minutes to partially polymerize the monomers.

As elastic particles, organic nano particles, which were a core-shell particle consisting of 70 wt % of a polybutylacrylate core and 30 wt % of a polymethylmethacrylate shell and had an average particle diameter of 200 nm, was prepared in an emulsion polymerization method.

100 parts by weight of the prepared acrylate polymer resin, 2 parts by weight of the elastic particles, and 0.01 parts by weight of an initiator (Irgacure651) were mixed in the reactor. The obtained viscous liquid was mixed with 0.3 parts by weight of the initiator (Irgacure651), 0.1 parts by weight of hexanedioldiacrylate as a crosslinking agent, 4 parts by weight of hollow particles (glass bubbles; 3M™ K1, a median particle diameter: 65 μm), and 0.1 parts by weight of fumed silica (AEROSIL 200) to prepare an elastic sheet composition having adhesiveness.

The elastic sheet composition was applied on a polyethyleneterephthalate (PET) film, which was a releasing film, and then, irradiated by ultraviolet rays with intensify of 2000 mJ/cm² to manufacture an elastic sheet adhered on the PET film. The elastic sheet had a thickness of about 300 μm.

### 2. Manufacturing of Positive Electrode

85 wt % of LiNi_{0.8}Co_{0.15}Mn_{0.05}O₂ coated with Li₂O—ZrO₂ as a positive electrode active material, 13.5 wt % of Li₆PS₅Cl as a lithium argyrodite type solid electrolyte, 1.0 wt % of polyvinylidene fluoride as a binder, and 0.5 wt % of carbon nanotube as a conductive material were mixed to prepare a positive electrode composition. The prepared positive electrode composition was coated on a positive electrode current collector by using a bar coater and then, dried and compressed to manufacture a positive electrode.

### 3. Manufacturing of Solid Electrolyte Layer

An argyrodite-type solid electrolyte Li₆PS₅Cl (D50=3 μm) was added to a binder solution prepared by dissolving an acryl-based binder (SX-A334, Zeon Corp.) in an isobutyryl isobutyrate (IBIB) solvent and then, stirred to prepare a slurry. The slurry included 98.5 wt % of the solid electrolyte and 1.5 wt % of the binder. The slurry was coated on a release PET film with a bar coater and then, dried at room temperature to form a solid electrolyte layer.

### 4. Manufacturing of Negative Electrode

After preparing an Ag/C composite by mixing carbon black with a primary particle diameter (D50) of about 30 nm and silver (Ag) with an average particle diameter (D50) of about 60 nm in a weight ratio of 3:1, 0.25 g of the composite was added to 2 g of an NMP solution including 7 wt % of a polyvinylidene fluoride binder and then, mixed to prepare a negative electrode coating layer composition. The negative electrode coating layer composition was coated on a nickel foil current collector with a bar coater and then, vacuum-dried to prepare a precipitation-type negative electrode having a negative electrode coating layer on the current collector.

5. Manufacturing of all-Solid-State Rechargeable Battery Cell

The negative electrode/solid electrolyte/positive electrode/solid electrolyte/negative electrode in order were stacked to manufacture a unit stack cell. An elastic sheet was interposed between two unit stack cells and on their outmost surfaces to manufacture a battery structure.

This combined structure was inserted into an aluminum laminate film pouch and then, subjected to warm isostatic press (WIP) at 80° C. under 500 Mpa for 30 minutes to manufacture an all-solid-state rechargeable battery cell. The aluminum pouch was unpacked to take out the battery structure stacked in order of elastic sheet/negative electrode/solid electrolyte/positive electrode/solid electrolyte/negative electrode/elastic sheet/negative electrode/solid electrolyte/positive electrode/solid electrolyte/negative electrode/elastic sheet.

In the pressurized state, the positive electrode active material layer had a thickness of about 100 μm, the negative electrode coating layer had a thickness of about 7 μm, the solid electrolyte layer had a thickness of about 60 μm, and the elastic sheet had a thickness of about 180 μm.

### Example 2

An elastic sheet and an all-solid-state rechargeable battery cell were manufactured substantially the same manner as in Example 1 except that a polyurethane resin (M5; Main Elecom Co., Ltd.) was used instead of the acrylate polymer resin.

### Example 3

40 parts by weight of propylene-based polyol with a weight average molecular weight of 4000 was mixed with 60 parts by weight of polyether-based polyol (viscosity (25° C.): 500 mPa·s, the number of functional groups: 3, a number average molecular weight: 3000, “GP-3000” manufactured by Sanyo Kasei Kogyo Co., Ltd.). Subsequently, 8 parts by weight of isocyanate (Lupranate T80, BASF) as a crosslinking agent was added to the obtained composition and then, stirred by injecting nitrogen at 100 cc/min for 5 minutes, coated on a PET film, and heated at 100° C. to 150° C. to form a 300 μm-thick sheet shaped elastic sheet.

Except for using this elastic sheet, an all-solid-state rechargeable battery cell was manufactured substantially the same manner as in Example 1.

### Comparative Example 1

In Example 1, 10 parts by weight of the hollow particles was applied.

### Comparative Example 2

In Example 1, the hollow particles were excluded.

### Comparative Example 3

In Example 2, the hollow particles were excluded.

### Comparative Example 4

In Example 3, the nitrogen was excluded.

### Evaluation Example 1: Evaluation of Physical Properties of Elastic Sheet

The elastic sheets according to Examples 1 and 2 and Comparative Examples 1 to 4 were measured with respect to compressive strength at CFD 70%, CFD 50%, and CFD 40% by using TA (Texture Analyzer, Stable Micro Systems), permanent strain by using a vernier caliper, and a shock absorption rate by using a ball drop device (Sensor 3050A040, Bruel&Khaer).

### (1) Permanent Strain

The permanent strain was calculated according to Calculation Equation 1 by placing a 1.5 mm-thick SUS plate on a 10 mm or more-thick stainless steel plate, stacking elastic sheet samples up to a thickness of 3 mm thereon, compressing the specimen with the 10 mm or more-thick stainless steel plate until the thickness became 1.5 mm by turning screws on the side, storing it at 50° C. for 7 days, and dismantling it to measure its thickness.

$$Permanent strain ( \% ) = \{ \vert ( thickness of specimen recovered after compression ) - ( 3 mm ) \vert / ( 3 mm ) \} \} \times 100 \qquad [ Calculation Equation 1 ]$$

### (2) Impact Absorption Rate

The impact absorption rate was calculated according to Calculation Equation 2 by dropping 7 g of a weight from a vertical height of 20 cm at 25° C. on one elastic sheet (300 μm) specimen to measure an impact force (N) generated from the ball drop in a ball drop method.

$$Impact absorption rate ( \% ) = \{ [ ( impact force measured without specimen ) - ( impact force on specimen ) ] / ( impact force measured without specimen ) \} \times 100 \qquad [ Calculation Equation 2 ]$$

### (3) Compressive Strength

The CFD 70% compressive strength was calculated according to Calculation Equation 3 by using a compression tester having a spherical shape jig with a diameter of 10 mm to apply a pressure to each specimen at a compression ratio of 0.6 mm/min (10 μm/sec) at 25° C. and thus obtain a load at a point where the specimen reached 30% of its initial thickness after the pressurization, and the result are shown in Table 1.

Herein, the specimen for the evaluation was obtained by stacking 15 elastic sheet samples with a thickness of 300 μm.

$$Compressive strength ( M P a ) = \{ [ Load at 70 \% compression ( kgf ) ] / [ area of specimen ( {cm}^{2} ) ] \} \times 0.1 \qquad [ Calculation Equation 3 ]$$

Likewise, the CFD 50% was obtained by compressive strength at a point where the specimen reached 50% of its initial thickness, and the CFD 40% was obtained by compressive strength at a point where the specimen reached 60% of its initial thickness, and the results are shown in Table 1.

The stress relaxation rate was calculated according to Calculation Equation 4 by obtaining a stress change for 60 seconds after compressing the elastic layer to 40 μm under a pressure condition of 2.5 kgf.

$$Stress relaxation rate ( \% ) = ( Stress after 60 seconds of 40 μm compression ) / ( Initial stress at 40 μm compression ) \times 100 \qquad [ Calculation Equation 4 ]$$

### Evaluation Example 2: Evaluation of Cycle-Life Characteristics of all-Solid-State Rechargeable Battery Cell

The all-solid-state rechargeable battery cells of Examples 1 to 3 and Comparative Examples 1 to 4 were charged to an upper limit voltage of 4.25 V at a constant current of 0.1 C and discharged to a cut-off voltage of 2.5 V at 0.1 C at 45° C. for initial charge and discharge. Subsequently, the cells were 300 times or more repeatedly charged and discharged within a voltage range of 2.5 V to 4.25 V at 0.33 C at 45° C. to check the number of cycles where discharge capacity retention was reduced to less than 90% of the initial discharge capacity, and the results are shown in Table 1.

TABLE 1

| | | | | Comparative | Comparative | Comparative | Comparative |
|---|---|---|---|---|---|---|---|
| | Example 1 | Example 2 | Example 3 | Example1 | Example2 | Example3 | Example4 |
| CFD 40% | 0.968 | 1.09 | 1.3 | 0.5105 | 1.24 | 1.3 | 1.54 |
| (MPa) | | | | | | | |
| CFD 50% | 1.278 | 1.46 | 1.46 | 0.7911 | 1.97 | 1.95 | 2.32 |
| (MPa) | | | | | | | |
| CFD 70% | 3.63 | 3.44 | 5.95 | 2.6913 | 7.89 | 6.584 | 9.72 |
| (MPa) | | | | | | | |
| Stress | 13% | 12% | 12% | 15% | 3% | 5% | 3% |
| relaxation | | | | | | | |
| rate (%) | | | | | | | |
| Permanent | 49% | 45% | 45% | 43% | 29% | 42% | 38% |
| strain (%) | | | | | | | |
| Impact | 54.70% | 52.1 | 52.1 | 51% | 48% | 49.5% | 41% |
| absorption | | | | | | | |
| rate (%) | | | | | | | |
| Cell cycle- | >300 | >300 | >300 | <100 | <100 | <100 | <100 |
| life (cycle) | | | | | | | |

Referring to Table 1, in Examples 1 to 3, the elastic sheets exhibited CFD 70% compressive strength in a range of 2.0 to 6.0 MPa, CFD 40% compressive strength in a range of 0.5 to 1.5 MPa, permanent strain of less than 50%, an impact absorption rate of greater than or equal to 50%, and the all-solid-state rechargeable battery cells of Examples 1 to 3 exhibited greater than or equal to 90% of capacity retention up to 300 cycles in the cycle-life characteristic evaluation, which confirmed excellent cycle-life characteristics. On the contrary, Comparative Example 1 exhibited CFD 40% compressive strength of less than 0.8 Mpa, Comparative Example 2 exhibited CFD 70% compressive strength of greater than 6.0 Mpa, and an impact absorption rate of 48%, Comparative Example 3 exhibited CFD 70% compressive strength of greater than 6.0 Mpa, an impact absorption rate of 49%, and Comparative Example 4 exhibited CFD 70% compressive strength of greater than 6 Mpa, and an impact absorption rate of less than 50%, which confirmed insufficient cycle-life characteristics of the all-solid-state rechargeable battery cells of Comparative Examples 1 to 4.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: all-solid-state battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. An elastic sheet for an all-solid-state rechargeable battery having a thickness of 100 m to 10 mm, a permanent strain of less than 50% at 45° C., an impact absorption rate of greater than or equal to 50% upon ball drop (7 g, 20 cm), and a compressive strength of 2.0 MPa to 6.0 MPa at CFD of 70%.

2. The elastic sheet for the all-solid-state rechargeable battery as claimed in claim 1, wherein
the compressive strength of the elastic sheet for an all-solid-state rechargeable battery at CFD of 40% is 0.5 MPa to 1.5 MPa.

3. The elastic sheet for the all-solid-state rechargeable battery as claimed in claim 1, wherein
the compressive strength of the elastic sheet for an all-solid-state rechargeable battery at CFD of 70% is at least three times the compressive strength at CFD of 40%.

4. The elastic sheet for the all-solid-state rechargeable battery as claimed in claim 1, wherein
a density of the elastic sheet for all-solid-state rechargeable battery is 0.3 g/cm³ to 0.9 g/cm³.

5. The elastic sheet for the all-solid-state rechargeable battery as claimed in claim 1, wherein
the elastic sheet for all-solid-state rechargeable battery comprises a polymer resin, and
the polymer resin comprises polyacrylate, polyurethane, silicone, a fluorine-based polymer, polyether polyol, polyester polyol, polycarbonate polyol, a copolymer thereof, or a combination thereof.

6. The elastic sheet for the all-solid-state rechargeable battery as claimed in claim 5, wherein
the polyacrylate is derived from C1 to C20 alkyl acrylate, hydroxy C1 to C20 alkyl acrylate, or a combination thereof.

7. The elastic sheet for the all-solid-state rechargeable battery as claimed in claim 5, wherein
the elastic sheet for all-solid-state rechargeable battery comprises hollow particles.

8. The elastic sheet for the all-solid-state rechargeable battery as claimed in claim 7, wherein
the hollow particles are included in an amount of 1 part by weight to 8 parts by weight based on 100 parts by weight of the binder resin.

9. The elastic sheet for the all-solid-state rechargeable battery as claimed in claim 7, wherein
the hollow particle comprises inorganic hollow particle, organic hollow particle, or a combination thereof,
the inorganic hollow particles comprise glass, metal oxide, metal carbide, metal fluoride, or a combination thereof, and
the organic hollow particles comprise an acrylic resin, a vinyl chloride resin, a urea resin, a phenol resin, or a combination thereof.

10. The elastic sheet for the all-solid-state rechargeable battery as claimed in claim 7, wherein
an average particle diameter (D50) of the hollow particles is 2 μm to 100 μm.

11. The elastic sheet for the all-solid-state rechargeable battery as claimed in claim 5, wherein
the elastic sheet for all-solid-state rechargeable battery further comprise elastic particles, and
the elastic particles are derived from alkyl acrylate, olefin, butadiene, isoprene, styrene, acrylonitrile, copolymers thereof, or a combination thereof.

12. The elastic sheet for the all-solid-state rechargeable battery as claimed in claim 11, wherein
the elastic particles are included in an amount of 0.1 parts by weight to 5 parts by weight based on 100 parts by weight of the polymer resin.

13. The elastic sheet for the all-solid-state rechargeable battery as claimed in claim 11, wherein
an average particle diameter (D50) of the elastic particles is 10 nm to 900 nm.

14. The elastic sheet for the all-solid-state rechargeable battery as claimed in claim 5, wherein
the elastic sheet for an all-solid-state rechargeable battery further comprises inorganic particles, and
the inorganic particles comprise alumina, titania, boehmite, barium sulfate, calcium carbonate, calcium phosphate, amorphous silica, mesoporous silica, fumed silica, crystalline glass particles, kaolin, talc, silica-alumina composite oxide particles, calcium fluoride, lithium fluoride, zeolite, molybdenum sulfide, mica, magnesium oxide, or a combination thereof.

15. The elastic sheet for the all-solid-state rechargeable battery as claimed in claim 14, wherein
the inorganic particles are included in an amount of 0.001 parts by weight to 50 parts by weight based on 100 parts by weight of the polymer resin.

16. The elastic sheet for the all-solid-state rechargeable battery as claimed in claim 5, wherein
the elastic sheet for all-solid-state rechargeable battery further comprises an additive, and
the additive comprises an initiator, a crosslinking agent, a coupling agent, a stabilizer, an inert gas, or a combination thereof.

17. An all-solid-state rechargeable battery, comprising
two or more unit cells, comprising
a positive electrode
a negative electrode, and
a solid electrolyte layer between the positive electrode and the negative electrode,
wherein the all-solid-state rechargeable battery comprises an elastic sheet according to claim 1, between the unit cells and/or at the outermost surface of the unit cells.
